(19) United States
(12) Patent Application Publication
(10) Pub. No.: US 2007/0010229 A1
(43) Pub. Date: Jan. 11, 2007

(54) Frequency conversion circuit tuner adopting same and set-top box for receiving CATV

(76) Inventor: Wataru Taki, Osaka (JP)

Correspondence Address: BIRCH STEWART KOLASCH & BIRCH, PO BOX 747, FALLS CHURCH, VA, 22040-0747, US

(21) Appl. No.: 11/519,837

(22) Filed: Sep. 13, 2006

Related U.S. Application Data
(62) Division of application No. 10/662,480, filed on Sep. 16, 2003.

(30) Foreign Application Priority Data
Oct. 4, 2002 (JP) 2002-292912

(51) Int. Cl. H04B 1/26; H04B 15/00

(52) U.S. Cl. 455/314

(57) ABSTRACT

A low pass filter for removing a high harmonic wave of an local oscillation signal LO1 is provided between the first stage local oscillation circuit and a mixer circuit, and a cut-of frequency of the low pass filter changes in response to the frequency of the local oscillation signal LO1. In the conventional structure, for the interference of high harmonic wave represented by an output spurious, simply inserting a low pass filter is not sufficient, and it is also necessary to provide a bypass filter, or the structure for more surely connecting the sealed cap or the substrate to ground, etc. In contrast, according to the foregoing structure of the present invention, even when receiving low frequency, the high harmonic wave can be attenuated to a sufficient level without a band width restriction, and such structure required in the conventional structure for the interference of high harmonic wave can be omitted, and a cost reduction or improved degree of freedom in design choice can be achieved.

This nonprovisional application claims priority under 35 U.S.C. § 119(a) on Patent Application No. 2002-292912 filed in Japan on Oct. 4, 2002, which is a Divisional of co-pending application Ser. No. 10/662,480, filed on Sep. 16, 2003, the entire contents of which are herein incorporated by reference.

### FIELD OF THE INVENTION

The present invention relates to a frequency conversion circuit or a frequency converter, capable of obtaining an output signal by performing a plural-stage frequency conversion of a high frequency input signal for use in an analog high frequency circuit adopted in a television receiving machine or a tuner section such as a measuring apparatus, etc., a tuner adopting a frequency conversion circuit and a set-top box for receiving CATV.

### BACKGROUND OF THE INVENTION

FIG. 13 is a block diagram illustrating an electric structure of a tuner 1 adopting a typical conventional frequency conversion circuit. This tuner 1 is adopted in a set-top box for receiving CATV, and from a high frequency receiving signal RF to be input from an input terminal 2, a receiving frequency band component is extracted from a high frequency filter 3 to be realized by a band pass filter, and is amplified by a high frequency amplifier 5 after the amplification is limited in an attenuator 4.

On the other hand, a local oscillation signal LO1 corresponding to a frequency to be received is prepared in a first stage of a local oscillation circuit 6, and is input in a first stage mixer circuit 8 via a low pass filter 7 to be mixed with a high frequency signal RF from the high frequency amplifier 5. The intermediate frequency signal IF1 of a predetermined frequency thus obtained is input in an intermediate frequency filter 9 realized by a band pass filter, and after its components are filtered, it is input to a second stage mixer circuit 10 to be mixed with a local oscillation signal LO2 of a predetermined frequency to be prepared in a second stage local oscillation circuit 11.

The intermediate frequency signal IF2 of a predetermined frequency obtained from the mixer circuit 10 is input in an intermediate frequency filter 12 realized by a band pass filter, and after is components are filtered, it is amplified in an intermediate frequency amplifier 13 to be output to a base band processing circuit from an output terminal 14.

The tuner 1 having the foregoing structure has a problem of a so-called local beat, i.e., a higher harmonic wave generated from the first stage local oscillating circuit 6 interferes a higher harmonic wave generated from the second stage local oscillating circuit 11 and is input in an intermediate frequency output band as unwanted signal.
LO1=RF+IF1
LO2=IF1−IF2, and

A component of the unwanted signal is given as:
(RF+IF1)×m±(IF1−IF2)×n,

where m and n are integers of not less than 2.

In the tuner for receiving CATV, such unwanted signal could be a cause of deterioration in image quality and sound quality.

For this reason, in the conventional tuner 1, the low pass filter 7 is provided between the local oscillating circuit 6 and the mixer circuit 8 so as to prevent a high harmonic wave ((RF+IF1)×m) of the local oscillation signal LO1 from entering to the mixer 8.

However, an upper limit value for the frequency of the local oscillation signal LO1 of the local oscillation circuit 6 has to be less than the cut-off frequency fc of the low pass filter 7. Therefore, the foregoing conventional technique presents such problem that the upper limit value for the receiving band width of the tuner 1 is limited, and the band cannot be broadened. Namely, with the frequency upper limit value for the local oscillation signal LO1 of not less than the cut-off frequency fc of the low pass filter 7, even the reference wave of the local oscillation signal LO1 is attenuated by the low pass filter 7.

For example, the receiving band (RF) of the tuner for receiving CATV is very wide, i.e., 54 to 860 MHz. In this tuner, assuming that the first stage intermediate frequency (IF1) is 1000 MHz, then, the frequency ranges for the first stage local oscillation signal LO1 would be from 1054 to 1860 MHz (RF+IF1). Accordingly, a twice of the high harmonic wave ((RF+IF1)×2) is in the range from 2108 to 3720 MHz, and it is difficult to ensure a sufficient attenuation with 2108 MHz by setting the cut-off frequency fc of the low pass filter k7 to around 2 GHz by passing the reference wave of 1860 MHz.

Here, for example, as illustrated in FIG. 14, the low pass filter 7 can be realized by using the condenser c and the coils 11 and 12 as illustrated in FIG. 14. However, when arranging the low pass filter 7 while satisfying high characteristics over the wide band, as is clear from the low pass filter 7a of FIG. 15, the number of stages increases, and the number of components and the number of parts to be adjusted increase, which leads to a cost increase. Alternately, when the instruction of the low pass filter 7 is not sufficient, it is necessary to provide other bypass condenser, or the structure for more surely connecting the sealed cap or the substrate to ground, etc.

With the conventional technique, as illustrated in FIG. 16(a) and FIG. 16(b), there exists a difference in attenuation of the high harmonic wave between when receiving a low frequency channel and when receiving a high frequency channel. Namely, as illustrated in FIG. 16(a) and FIG. 16(b), when receiving a high frequency channel, the frequency f of the reference wave of the local oscillation signal LO1 is high, and there exists a great difference between the frequency 2f, 3f of the high harmonic wave (the lower order in particular) and the cut-off frequency fc of the low pass filter 7. on the other hand, as illustrated in FIG. 16(b), when receiving the low frequency channel, the frequency f of the reference wave is low, and there exists a small difference between the frequency 2f and 3f of the high harmonic wave and the cut off frequency fc is small, which leads to a small amount of attenuation of the high harmonic wave.

### SUMMARY OF THE INVENTION

It is an object of the present invention to provide a frequency conversion circuit or a frequency converter, which permits a high harmonic wave to be attenuated to a sufficient level even when receiving low frequency and which is applicable to a wide frequency band without a band width restriction, a tuner adopting such frequency conversion circuit or frequency converter and a CATV receiving set top box adopting the tuner.

In order to achieve the above object, the frequency conversion circuit of the present invention which performs a two-stage frequency conversion of a high frequency input signal of the present invention may be arranged so as to include a variable frequency filter for removing a high harmonic wave of a first stage local oscillation signal.

The frequency conversion circuit of the foregoing structure is applicable to, for example, a cable television broadcast receiving set box, which performs a two-stage frequency conversion of a high frequency input signal to obtain an output signal as desired, such as a base band signal, and is provided with the variable frequency filter which is realized, for example, by a low pass filter, or a band pass filter, etc., for removing a high harmonic wave of the first stage local oscillation signal. In this frequency conversion circuit, which carries out two-stage frequency conversion, the first stage local oscillation signal changes in response to a change in frequency of the high frequency input signal; however, the band to be filtered by the variable frequency filter changes in response to a change in frequency of the high frequency input signal. Therefore, the frequency conversion circuit of the foregoing structure is free from the band width restriction, and is applicable to wide frequency band. Particularly, for the high frequency input signal of low frequency (i.e., the frequency of the first stage local oscillation signal is low), the reference wave component of the first stage local oscillation signal can be passed, and its high harmonic wave can be attenuated to a sufficient level.

By attenuating the high harmonic wave of the first stage local oscillation signal to a sufficient level, the problem of a local beat due to an interference between the high harmonic wave of the first stage local oscillation signal and the high harmonic wave of the second stage local oscillation signal can be eliminated.

Another frequency conversion circuit of the present invention which performs a two-stage frequency conversion of a high frequency input signal, is arranged so as to include a variable frequency filter whose blocking frequency changes in response to a change in oscillation frequency of the first stage local oscillation signal, for blocking an interference between a high harmonic wave of the first stage oscillation signal and a high harmonic wave of a second stage local oscillation signal.

With this structure, the first stage local oscillation signal changes in response to a change in frequency of the high frequency input signal. However, the frequency conversion circuit is provided with a variable frequency filter whose blocking frequency changes in response to a change in oscillation frequency of the first stage local oscillation signal, for blocking an interference between a high harmonic wave of the first stage oscillation signal and a high harmonic wave of the second stage local oscillation signal.

Therefore, the frequency conversion circuit of the foregoing structure is free from the band width restriction, and is applicable to wide frequency band. Particularly, for the high frequency input signal of low frequency (i.e., the frequency of the first stage local oscillation signal is low), the reference wave component of the first stage local oscillation signal can be passed, and its high harmonic wave can be attenuated to a sufficient level. As a result, the problem of a local beat due to an interference between the high harmonic wave of the first stage local oscillation signal and the high harmonic wave of the second stage local oscillation signal can be eliminated.

In order to achieve the above object, another frequency conversion circuit in accordance with the present invention which performs a plural-stage frequency conversion of a high frequency input signal is arranged so as to include: a local oscillation circuit for generating a local oscillation signal of variable frequency; a mixer circuit corresponding to the local oscillation circuit; and a variable frequency filter for blocking an interference between a high harmonic wave of the local oscillation signal of variable frequency and a high harmonic wave of a local oscillation circuit from a remaining local oscillation circuit, the variable frequency filter being provided between the local oscillation circuit and the mixer circuit.

In the frequency conversion circuit of the foregoing structure, which performs a plural-stage frequency conversion, the local oscillation circuit, which generates a local oscillation signal of variable frequency (for example, a local oscillation signal whose oscillation frequency changes in response to a change in frequency of the high frequency input signal) is provided in at least one of the plural stages. For the local oscillation signal from the local oscillation circuit, the high harmonic wave component is attenuated by the variable oscillation signal before being input to the corresponding mixer circuit. Here, since variable filter is adopted, the band to be filtered can be changed in response to a change in frequency of the local oscillation circuit. Therefore, the frequency conversion circuit of the foregoing structure is free from the band width restriction, and is applicable to wide frequency band. Particularly, for the high frequency input signal of low frequency, the reference wave component of the first stage local oscillation signal can be passed, and its high harmonic wave can be attenuated to a sufficient level.

By attenuating the high harmonic wave of the first stage local oscillation signal to a sufficient level, the problem of a local beat due to an interference between the high harmonic wave of the first stage local oscillation signal and the high harmonic wave of the second stage local oscillation signal can be eliminated.

In order to achieve the above object, the frequency converter of the present invention which performs a plural-stage frequency conversion of a high frequency input signal, which includes plural-stage frequency converting sections, each including a local oscillation circuit for generating a local oscillation signal and a mixer circuit for converting a frequency of a signal by mixing the signal with the local oscillation signal, is characterized by comprising:

a variable frequency filter which permits a local oscillation signal to pass therethrough while removing a high harmonic component of the local oscillation signal, the variable frequency filter being provided between the local oscillation circuit for generating local oscillation signals of different frequencies and the mixer circuit.

It is preferable that the above frequency converter be further arranged such that the plural-stage frequency converting sections are two-stage frequency converting sections, wherein the variable frequency filter is provided between the local oscillation circuit and the mixer circuit in the first stage of the frequency converting section.

For the variable frequency filter, a variable low pass filter may be adopted.

For the variable frequency filter, a variable band pass filter may be adopted.

It is preferable that the above frequency converter be arranged so as to further include: a control section for changing frequency characteristics of a variable frequency filter in response to a change in oscillation frequency of the local oscillation circuit.

It is also preferable that the above frequency converter be arranged such that the control section includes a PLL which controls the local oscillation signal generated by the local oscillation circuit and the frequency characteristic of the variable frequency filter in relation to one another based on the oscillation frequency of the local oscillation circuit.

It is also preferable that the above frequency converter be arranged such that the control section adopts the voltage synthesizer method to perform a switch control of the frequency characteristic of the variable frequency filter according to the switch of the oscillation frequency of the local oscillation circuit.

It is also preferable that the above frequency converter be arranged such that a local amplifier is connected in series with the variable frequency filter between the local oscillation circuit and the mixer circuit.

It is also preferable that the above frequency converter be arranged such that a local amplifier is provided between the local oscillation circuit and the mixer circuit;

the variable frequency filter is provided either between the local oscillation circuit and the local amplifier, or between the local amplifier and the mixer circuit; and

a low pass filter of a fixed frequency is provided either between the local oscillation circuit and the local amplifier or between the local amplifier and the mixer circuit, where the variable frequency filter is not provided.

In order to achieve the above object, another frequency converter of the present invention which performs a plural-stage frequency conversion of a high frequency input signal, which comprises plural-stage frequency converting sections, each including a local oscillation circuit for generating a local oscillation signal and a mixer circuit for converting a frequency of a signal by mixing the signal with the local oscillation signal, is characterized by further comprising:

a variable frequency filter whose blocking frequency changes in response to a change in oscillation frequency of a first stage local oscillation signal, for blocking an interference between high harmonic waves of different stages.

In order to achieve the above object, another tuner of the present invention is characterized by adopting a frequency converter which performs a plural-stage frequency conversion of a high frequency input signal, the frequency converter comprising plural-stage frequency converting sections, each including a local oscillation circuit for generating a local oscillation signal and a mixer circuit for converting a frequency of a signal by mixing the signal with the local oscillation signal, the frequency converter further comprising: a variable frequency filter which permits a local oscillation signal to pass therethrough while removing a high harmonic component of the local oscillation signal, the variable frequency filter being provided between the local oscillation circuit for generating local oscillation signals of different frequencies and the mixer circuit.

In order to achieve the above object, a still another tuner of the present invention is characterized by adopting a frequency converter which performs a plural-stage frequency conversion of a high frequency input signal, the frequency converter comprising plural-stage frequency converting sections, each including a local oscillation circuit for generating a local oscillation signal and a mixer circuit for converting a frequency of a signal by mixing the signal with the local oscillation signal, the frequency converter further comprising: a variable frequency filter whose blocking frequency changes in response to a change in oscillation frequency of a first stage local oscillation signal, for blocking an interference between high harmonic waves of different stages.

In order to achieve the above object, another CATV receiving set top box of the present invention is characterized by comprising a tuner adopting a frequency converter which performs a plural-stage frequency conversion of a high frequency input signal, the frequency converter comprising plural-stage frequency converting sections, each including a local oscillation circuit for generating a local oscillation signal and a mixer circuit for converting a frequency of a signal by mixing the signal with the local oscillation signal, the frequency converter further comprising:

a variable frequency filter which permits a local oscillation signal to pass therethrough while removing a high harmonic component of the local oscillation signal, the variable frequency filter being provided between the local oscillation circuit for generating local oscillation signals of different frequencies and the mixer circuit.

In order to achieve the above object, another CATV receiving set top box comprising a tuner adopting a frequency converter which performs a plural-stage frequency conversion of a high frequency input signal, the frequency converter comprising plural-stage frequency converting sections, each including a local oscillation circuit for generating a local oscillation signal and a mixer circuit for converting a frequency of a signal by mixing the signal with the local oscillation signal, the frequency converter further comprising:

a variable frequency filter whose blocking frequency changes in response to a change in oscillation frequency of a first stage local oscillation signal, for blocking an interference between high harmonic waves of different stages.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram illustrating an electric structure of a tuner adopting a frequency conversion circuit in accordance with one embodiment of the present invention;

FIG. 2 is an electric circuit diagram illustrating one example structure of a low pass filter in the tuner of FIG. 1;

FIG. 3 is a block diagram illustrating one example structure in which a cut-off frequency of the low pass filter in the tuner of FIG. 1 is variable;

FIG. 4 is a block diagram illustrating another example structure in which a cut-off frequency of a low pass filter in the tuner of FIG. 1 is variable;

FIG. 5(a) and FIG. 5(b) are graphs, which explain operations of the tuner of FIG. 1;

FIG. 6 is a block diagram illustrating an electric structure for the tuner adopting the frequency conversion circuit in accordance with the second embodiment of the present invention;

FIG. 7(a) and FIG. 7(b) are graphs, which explain operations of the tuner of FIG. 6;

FIG. 8 is a block diagram illustrating an electric structure of one example of a tuner adopting a frequency conversion circuit in accordance with the third embodiment of the present invention;

FIG. 9 is a block diagram illustrating an electric structure in accordance with another example of a tuner adopting a frequency conversion circuit in accordance with the third embodiment of the present invention;

FIG. 10 is a block diagram illustrating an electric structure of still another example of a tuner adopting a frequency conversion circuit in accordance with the third embodiment of the present invention;

FIG. 11 is a block diagram illustrating an electric structure of one example of a tuner adopting a frequency conversion circuit in accordance with the fourth embodiment of the present invention;

FIG. 12 is a block diagram illustrating an electric structure in accordance with another example of a tuner adopting a frequency conversion circuit in accordance with the fourth embodiment of the present invention;

FIG. 13 is a block diagram illustrating an electric structure of a tuner adopting a conventional frequency conversion circuit;

FIG. 14 is an electric circuit diagram illustrating one example structure for a low pass filter in a tuner shown in FIG. 13;

FIG. 15 is an electric circuit diagram illustrating another structure for the low pass filter in the tuner of FIG. 13; and

FIG. 16(a) and FIG. 16(b) are graphs, which explain operations of the tuner shown in FIG. 13.

### DESCRIPTION OF THE EMBODIMENTS

### First Embodiment

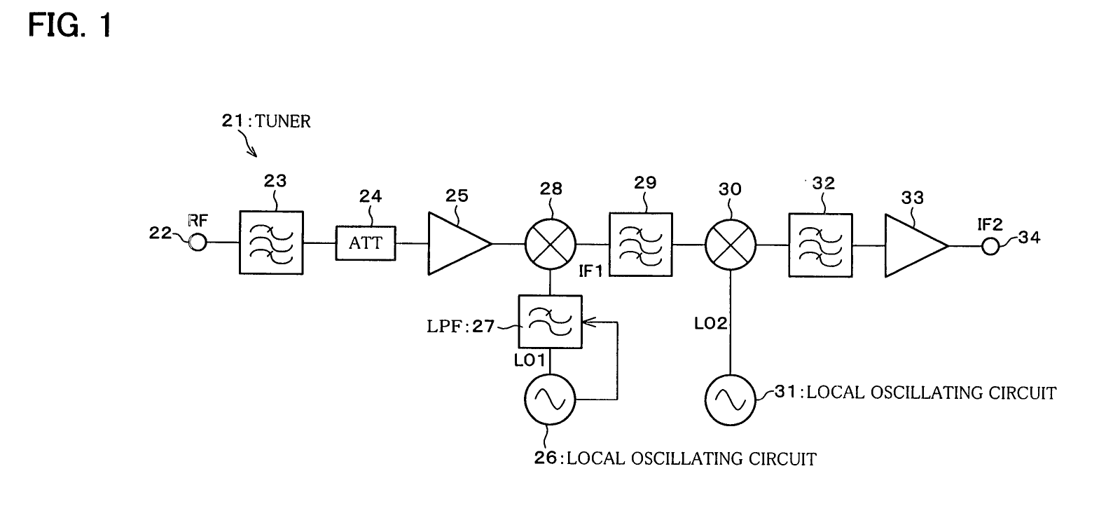

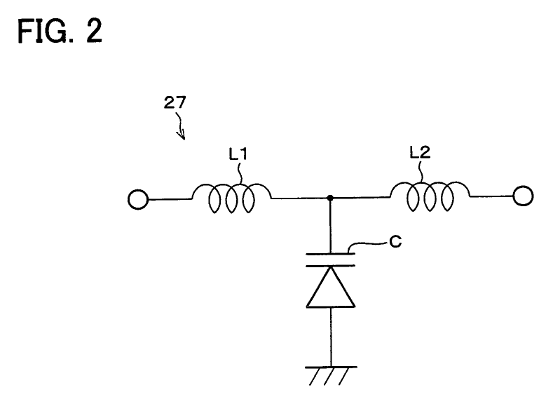

The following descriptions will explain one embodiment of the present invention in reference to FIGS. 1 and 2.

FIG. 1 is a block diagram illustrating an electric structure of a tuner 21 adopting a double conversion circuit as a frequency conversion circuit in accordance with one embodiment of the present invention. This tuner 21 is adopted in a set-top box for receiving CATV of wide frequency band of a high harmonic input signal. From a high frequency receiving signal RF to be input from a input terminal 22, a receiving frequency band component is extracted in a high frequency filter 23 realized by a band pass filter, and after an amplification is restricted in an attenuator 24, it is amplified in a high frequency amplifier 25.

On the other hand, the local oscillation signal LO1 corresponding to a frequency to be received is prepared in a first stage local oscillation circuit 26 and is input to a first stage mixer circuit 28 via a low pass filter 27 to be mixed with a high frequency signal RF from the high frequency amplifier 25. The intermediate frequency signal IF1 of a predetermined frequency obtained by the first stage frequency conversion in the mixer circuit 28 is input to the intermediate frequency filter 29 realized by the band pass filter, and after the components thereof are filtered, it is input to a second stage mixer circuit 30 to be mixed with a local oscillation signal LO2 of a predetermined fixed frequency prepared in the second stage local oscillation circuit 31.

The intermediate frequency signal IF2 of a predetermined frequency obtained by the second stage frequency conversion in the mixer circuit 30 is input to the intermediate filter 32 realized by a band pass filter, and after the component thereof is filtered, it is amplified in the intermediate frequency amplifier 33, and the resulting signal as amplified is output to a base band processing circuit (not shown) from the output terminal 34.

The characteristic feature of the present invention lies in that in the tuner 21, the low pass filter 27 is realized by a variable frequency filter in which the frequency band to be filtered (frequency to be blocked) varies in response to a frequency of the high harmonic input signal RF to be selected, i.e., an oscillation frequency of the first stage local oscillation circuit 25. For this reason, a control signal is input so that a cut-off frequency fc of the low pass filter 27 changes in accordance with the oscillation frequency. For this low pass filter 27, a low pass filter adopting a variable capacitor C and coils L1 and L2 realized by a variable capacitor diode, for example, shown in FIG. 2, can be realized, and the cut-off frequency fc can be varied by changing the application voltage to the variable capacitor C due to the control signal.

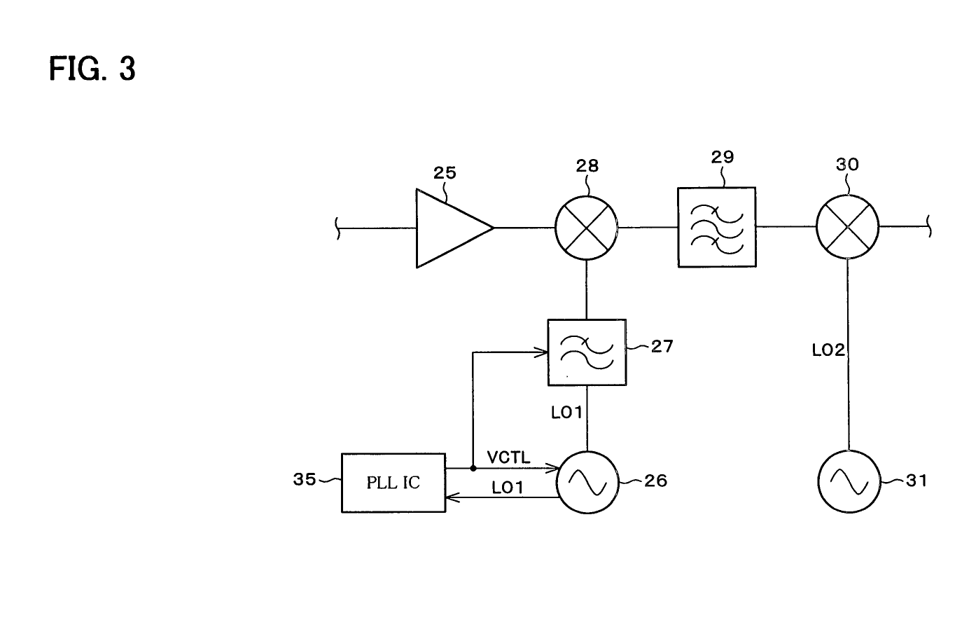

As illustrated in FIG. 3, for the control signal, it may be arranged so as to control at the same time when the receiving channel of the local oscillation circuit 26 controls using the PLLIC (control section) 35. Namely, in the structure adopting the voltage control oscillation circuit for the local oscillation circuit 26, the tuning voltage VCTL may be used without modification so that the PLLIC 35 can oscillate the local oscillation circuit 26 with a predetermined frequency. The PLLIC 35 generates the tuning voltage VCTL based on the local oscillation signal LO1 from the local oscillation circuit 26, and the resulting tuning voltage is output to the local oscillation circuit 26 and the low pass filter 27, thereby controlling the frequency characteristic of the low pass filter 27 in response to a change in frequency of the local oscillation signal LO1 generated by the local oscillation circuit 26.

However, in the foregoing control structure adopting the phase lock loop, to the variable capacity in the local oscillation circuit 26 and the variable capacity in the low pass filter 27, only the same synchronous voltage VCTL can be applied, and it is difficult to realize a control in combination of variable range of cut-off frequency fc of the low pass filter 27 and a follow-up control.

In view of the foregoing problem, it is effective to control using the voltage synthesizer. In this voltage synthesizer method, a circuit, which generates a predetermined plurality of control signal voltages (voltage corresponding to various plural receiving bands), is provided for each of the local oscillation circuit 26 and the low pass filter 27, and upon selecting one of the voltages to be applied to the local oscillation circuit 26, a control signal voltage to be applied to the low pass filter 27 in response to the selected voltage is selected.

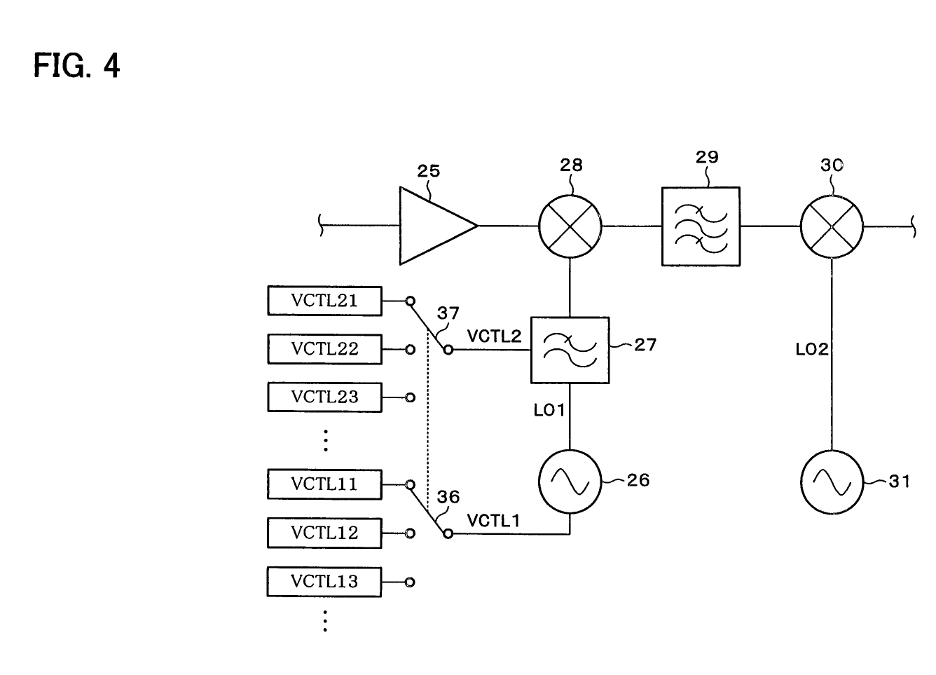

An example, which realizes a control using the voltage synthesizer method is shown in FIG. 4. In the structure shown in FIG. 4, it may be arranged such that in accordance with plurality of receiving bands, a circuit which generates tuning voltages VCTL 11, VCTL 12, VCTL 13, . . . ; and a circuit which generates tuning voltages VCTL 21, VCTL 22, VCTL 23, . . . to be applied to the low pass filter 27 and the local oscillation circuit 26 respectively are prepared beforehand, and a switching between the tuning voltage VCTL1 and the tuning voltage VCTL2 is controlled by cooperative switches 36 and 37 which operate mechanical dials, etc. With the foregoing structure adopting the control section of voltage synthesizer method provided with the circuits for generating the tuning voltage VCTL1 and the tuning voltage VCTL2 and the cooperative switches 36 and 37, it is possible to set the tuning voltage VCTL1 and the tuning voltage VCTL2 to be applied to the local oscillation circuit 26 and the low pass filter 27 separately, thereby improving design choice and adjustment.

Incidentally, it should be noted here that as long as the control section for controlling the low pass filter 27 can control the frequency characteristic of the low pass filler 27 in response to a change in frequency of the local oscillation signal LO1, the present invention is not intended to be limited to the phase lock loop method or the voltage synthesizer method.

The tuner 21 for wide frequency band in accordance with the present embodiment adopts a variable frequency filter for the low pass filter 27 to be provided between the 1st stage local oscillation circuit 26 and the mixer circuit 28 which permits the cut-off frequency fc to be varied in response to the a change in receiving frequency to be applicable to a wide frequency band without being restricted by the band width. Further, by adopting the first stage low pass filter shown in FIG. 2, a sufficient attenuation amount of sufficient high harmonic wave can be ensured even when receiving low frequency, thereby suppressing deterioration in image quality due to local beat.

In the conventional structure, for the interference of high harmonic wave represented by an output spurious, simply inserting a low pass filter is not sufficient, and it is also necessary to provide a bypass filter, or the structure for more surely connecting the sealed cap or the substrate to ground, etc. In contrast, according to the foregoing structure of the present invention, such structure required in the conventional structure for the interference of high harmonic wave can be omitted, and a cost reduction or improved degree of freedom in design choice can be achieved.

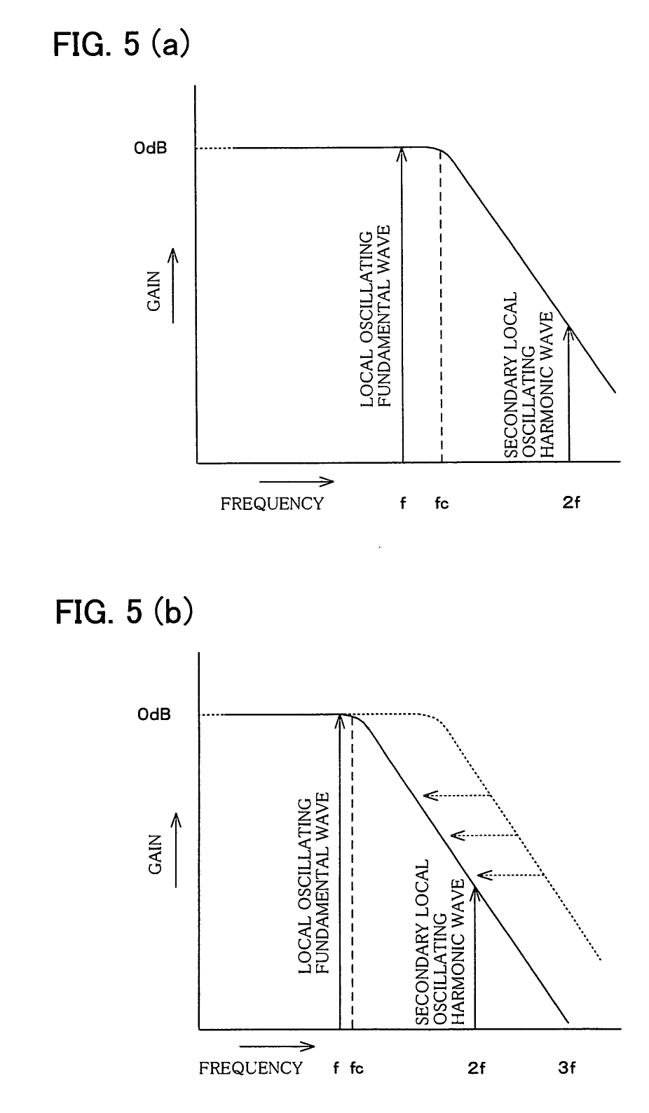

FIG. 5(a) and FIG. 5(b) are graphs, which explain operations of the tuner 21 having the foregoing structure. FIG. 5(a) shows frequency characteristic of the low pass filter 27 when receiving high frequency channel, and FIG. 5(b) shows frequency characteristics of the low pass filter 27 when receiving low frequency channel.

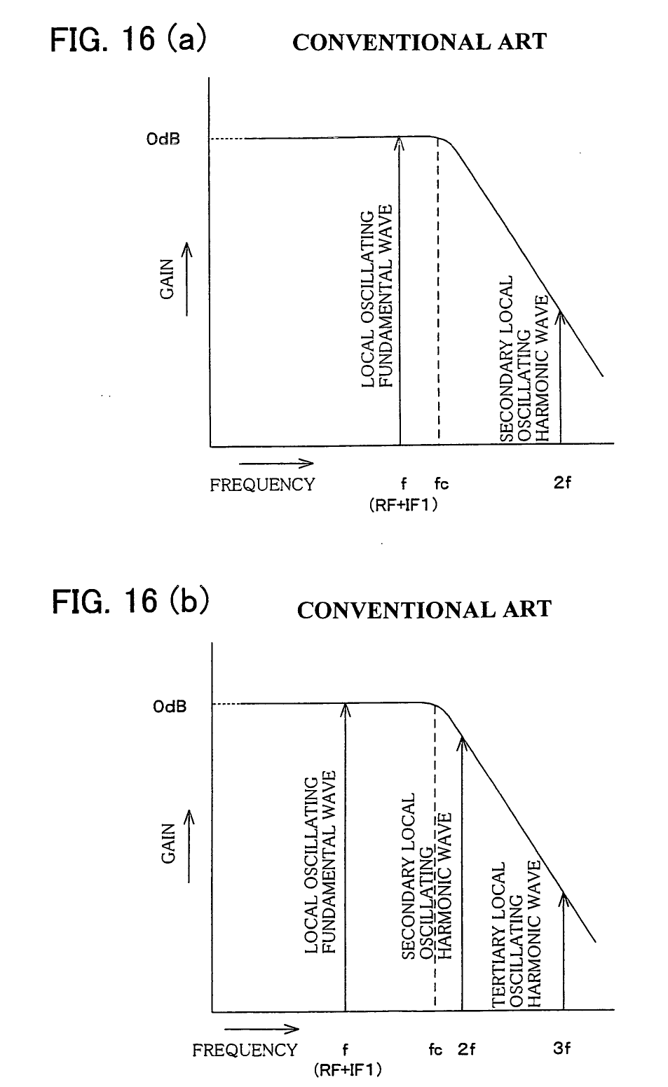

As is clear when comparing the characteristics of the conventional tuner 1 shown in FIGS. 16(a) and 16(b), when receiving a high frequency channel, a high harmonic wave component is attenuated while passing a reference wave of the local oscillation signal LO1.

In contrast, when receiving a low frequency channel, both the conventional structure and the structure of the present invention allow the reference wave component to pass. However, differences lie in the following. That is, in the conventional structure, however, the cut-off frequency fc is fixed, which causes a problem that particularly the lower order in the high harmonic wave and the cut-off frequency fc are approximated, and the attenuation in high harmonic wave is not sufficient. In contrast, in the present embodiment, by subtracting the cut-off frequency fc shown by the solid line from the frequency characteristic when receiving high frequency channel shown by the dotted line in FIG. 5(b), the lower order high harmonic wave can be set apart from the cut-off frequency fc, and whereby, a sufficient attenuation for the high harmonic wave can be obtained.

### Second Embodiment

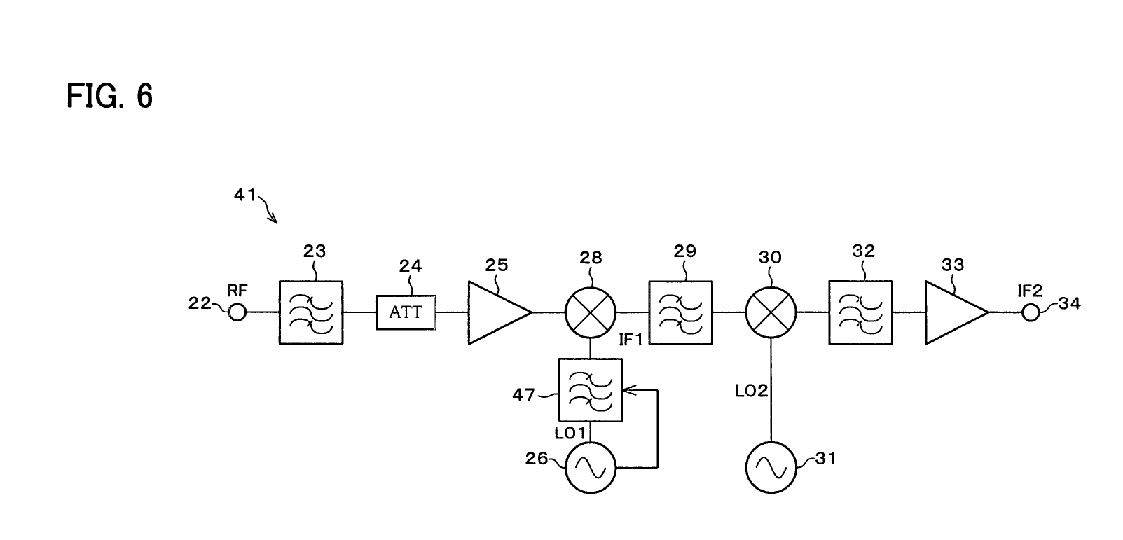

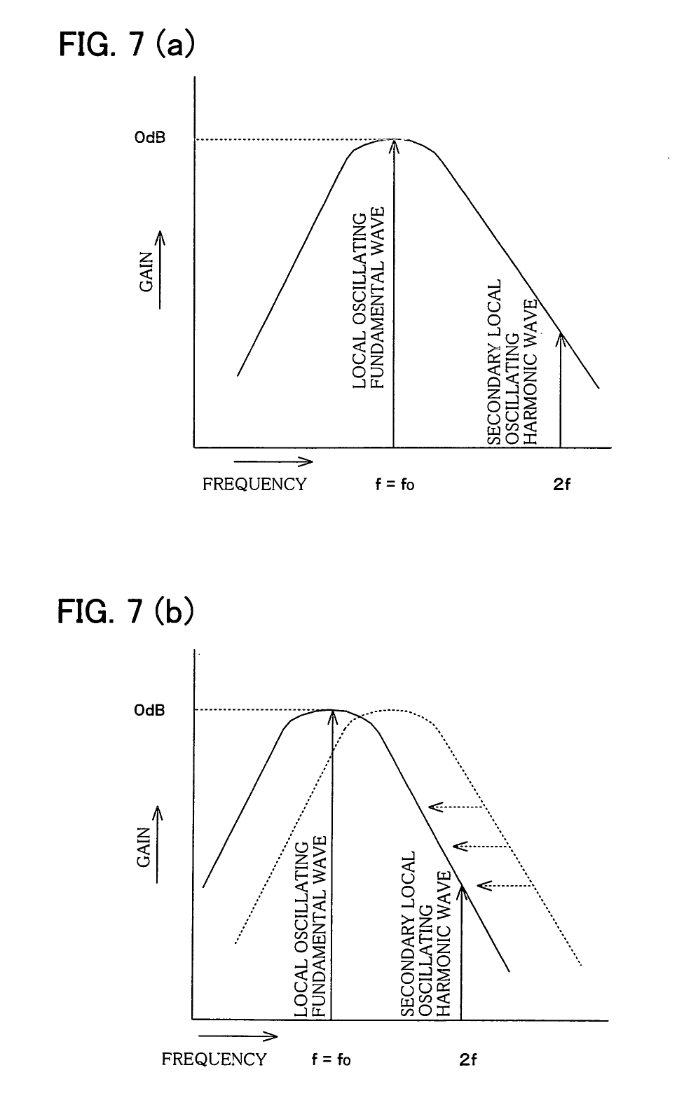

The following descriptions will explain the second embodiment of the present invention in reference to FIG. 6 and FIGS. 7(a) and 7(b).

FIG. 6 is a block diagram showing the electric structure of the tuner 41 as a frequency conversion circuit in accordance with the second embodiment of the present invention. This tuner 41 has a similar structure to the tuner 21 adopting the first embodiment, and therefore, members (structures) having the same functions as those shown in the drawings pertaining to the first embodiment above will be given the same reference symbols, and explanation thereof will be omitted here. The characteristic structure of the tuner 41 of the present embodiment lies in that a band pass filter 47 of variable frequency is adopted in replace of the low pass filter 27 of variable frequency. This band pass filter 47 is realized by, for example, an LC oscillation circuit in which, for example, a coil, and a variable capacitor such as a variable capacitor diode are combined. To this band pass filter 47, the control signal is input so as to vary the center frequency of the band pass filter 27 in accordance with the oscillation frequency to be applied to the variable capacitor.

In the case of adopting the low pass filter, at least three components are required; whereas, by adopting the foregoing band pass filter 47 composed of the LC oscillation circuit, the minimum number of components required can be reduced to two, thereby realizing a cost reduction.

FIG. 7(a) and FIG. 7(b) are graphs which explain operations of the tuner having the foregoing structure. FIG. 7(a) shows frequency characteristics of the band pass filter 47 when receiving the high frequency channel, while FIG. 7(b) indicates frequency characteristics when receiving the low frequency channel.

Similar to the tuner 21 of FIG. 5, at high frequency, components of high harmonic wave are attenuated while passing the components of reference waves of the local oscillation signal LO1. Also, at low frequency, with changes as indicated from the dotted line to the solid line in FIG. 7(b), the high harmonic wave of lower order is attenuated while passing the components of reference wave so that the central frequency f0 coincides with the frequency of the reference wave.

### Third Embodiment

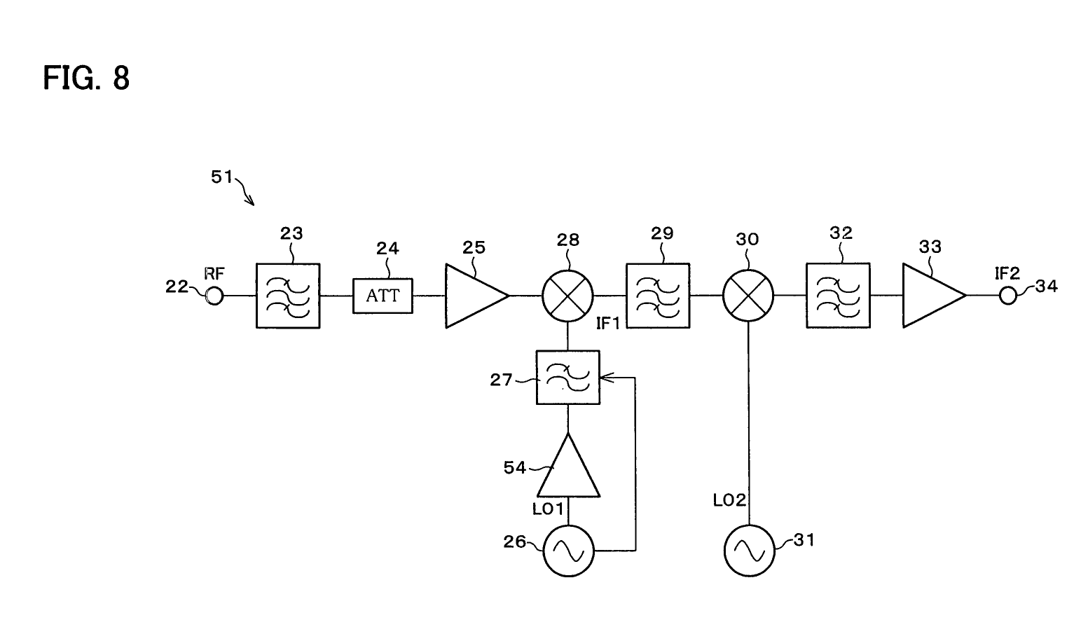

The following descriptions will explain the third embodiment of the present invention in reference to FIG. 8 to FIG. 10.

FIG. 8 to 10 are block diagrams respectively showing electric structures of the tuners 51, 52, and 53 adopting the frequency conversion circuit of the present embodiment. These tuners 51, 52 and 53 have similar structures to the tuners 21 and 41 in accordance with the first or second embodiments, and therefore, members (structures) having the same functions as those shown in the drawings pertaining to the first and second embodiments above will be given the same reference symbols, and explanation thereof will be omitted here. For these tuners 51, 52 and 53, the low pass filter 27 of the tuner 21 is adopted; however, the band pass filter 47 of the tuner 41 may be adopted as well.

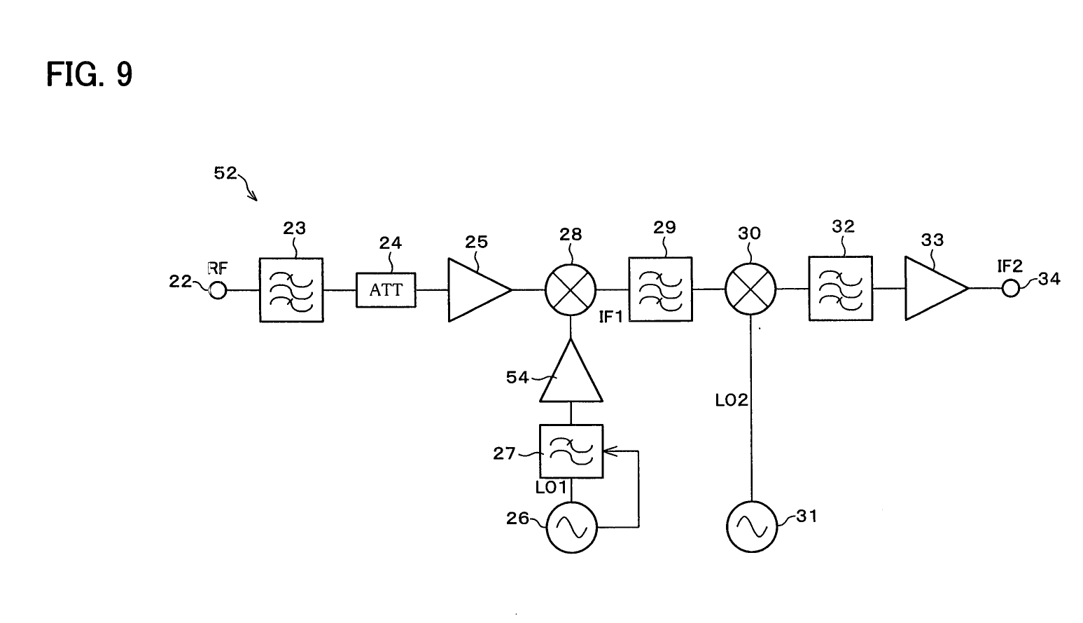

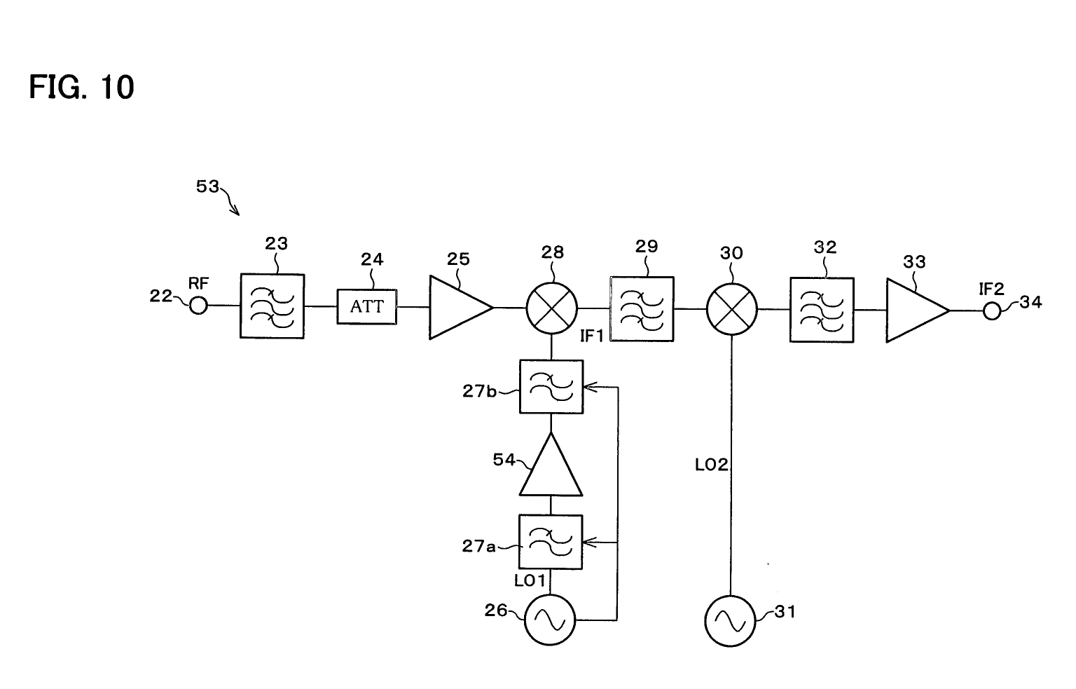

The characteristic feature of each of the tuners 51, 52 and 53 lies in that a local amplifier 54 for amplifying the local oscillation signal is provided between the first stage local oscillation circuit 26 and the first stage mixer circuit 28. In the tuner 51 of FIG. 8, the low pass filter 27 is provided after the local amplifier 54, i.e., between the local amplifier 54 and the mixer circuit 28. In the tuner 52 of FIG. 9, the low pass filter 27 is provided before the local amplifier 54, i.e., between the local oscillation circuit 26 and the local amplifier 54. In the tuner 53 of FIG. 10, the low pass filter is divided into two stages as indicates by reference numerals 27a and 27b, and the low pass filters 27a and the low pass filter 27b are provided before and after the local amplifier 54, i.e., between the local oscillation circuit 26 and the local amplifier 54, and between the local amplifier 54 and the mixer circuit 28.

Therefore, in amplifying the local oscillation signal LO1 by the local amplifier 54, when providing the low pass filter 27 before the local amplifier 54, the amplification of the high harmonic wave generated by the local oscillation circuit 26 can be prevented, and by providing the low pass filter 27 after the local amplifier 54, not only the high harmonic wave generated by the local oscillation circuit 26 but also the newly generated high harmonic wave by the local amplifier 54 can be attenuated. Namely, by providing two low pass filters 27a and 27b before and after the local amplifier 54, the foregoing two effects can be obtained.

Here, it is preferable to set the position of the low pass filter 27, i.e., before or after the local amplifier 45 based on the spurious characteristics due to the high harmonic wave of the local oscillation circuit 26 or the local amplifier 54. In normal cases, in order to prevent high harmonic wave generated by the local oscillation circuit 26 and the local amplifier 54, it is effective to provide the low pass filter 27 after the local amplifier 54. However, for such case where the skew characteristic of the local amplifier 54 is good, and the skew characteristic of the local oscillation circuit 26 is very poor, the n times wave generated by the local oscillation circuit and n±1 times wave generated from the local oscillation circuit 26 interfere each other at the local amplifier 54, and could be transferred on the same wave as the reference wave. In this case, it is preferable to provide the low pass filter 27 before the local amplifier 54 to fully attenuate the high harmonic wave.

### Fourth Embodiment

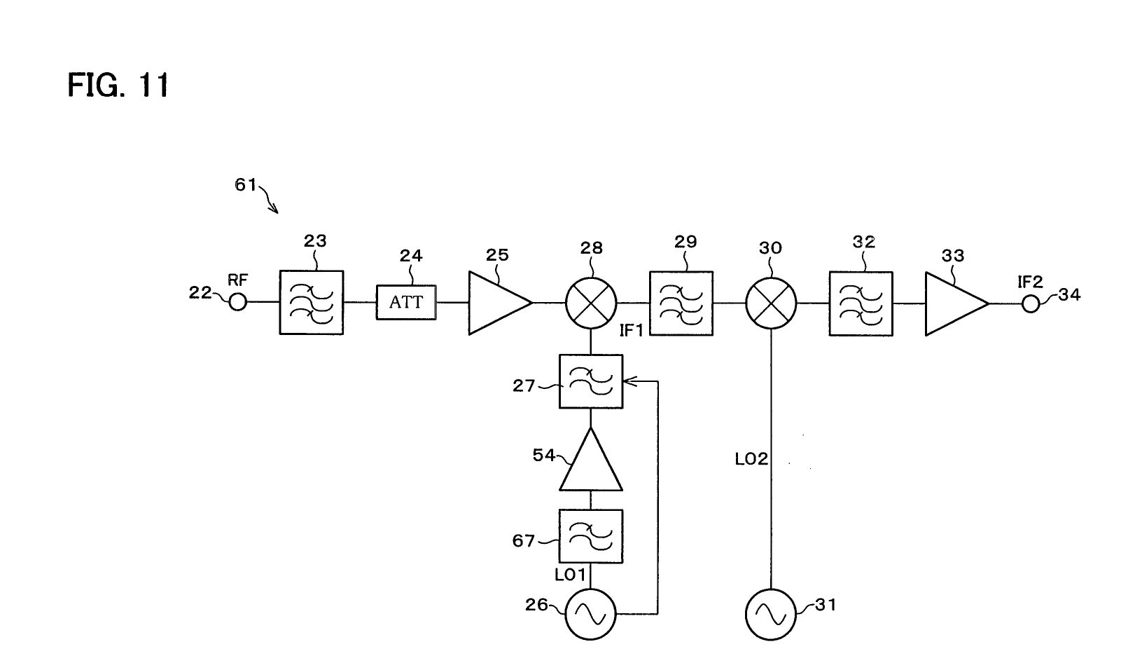

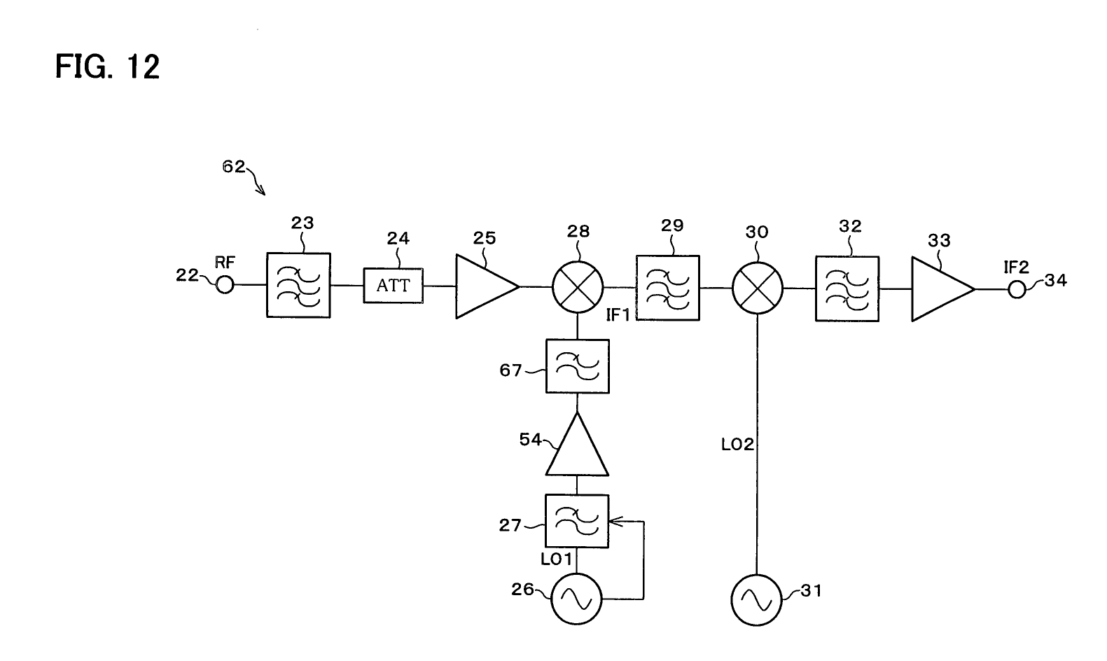

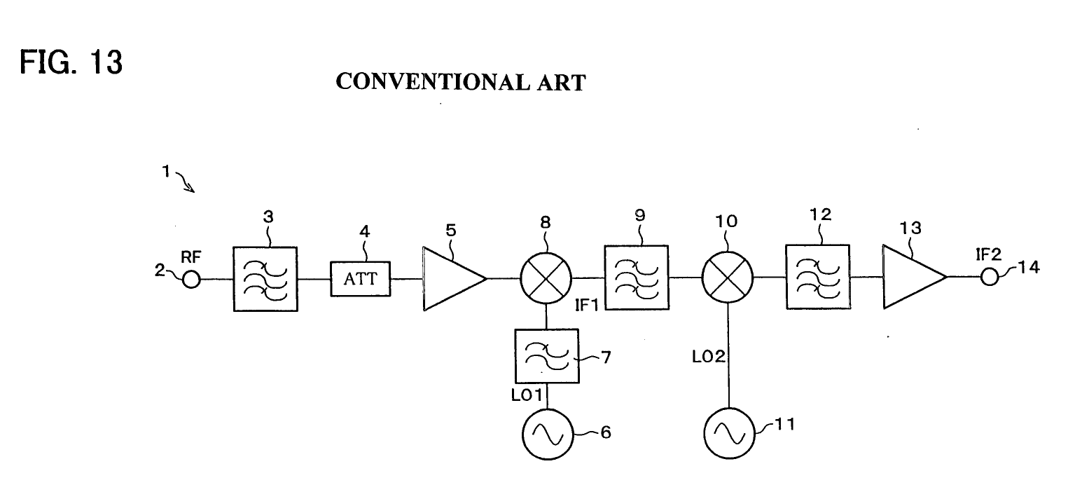

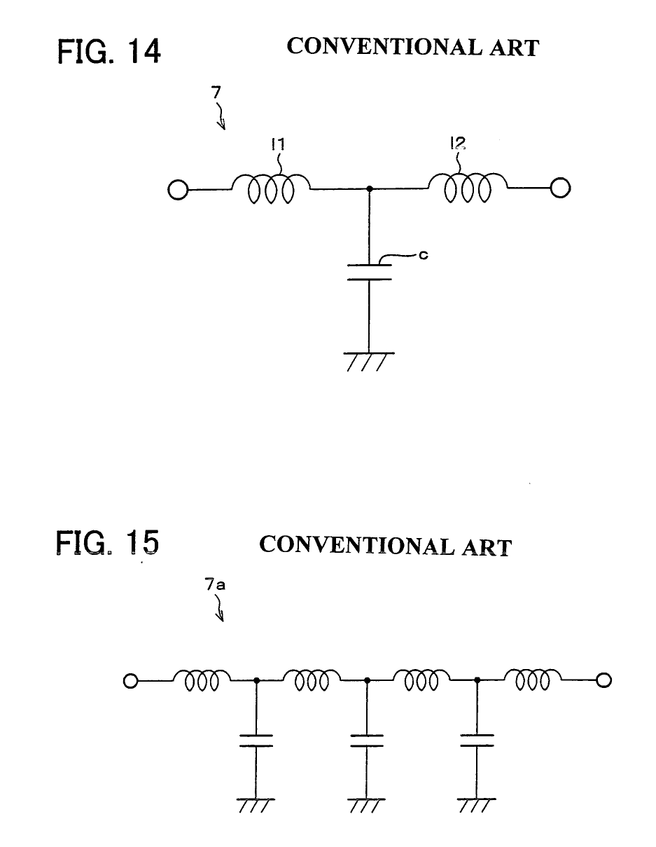

The following descriptions will explain the fourth embodiment of the present invention in reference to FIG. 11 and FIG. 12.

FIG. 11 and FIG. 12 are block diagrams illustrating the electric structure of tuners 61 and 62 adopting the frequency conversion circuit in accordance with the fourth embodiment of the present invention. These tuners 61 and 63 have similar structures to the tuner 53 in accordance with the third embodiment, and therefore, members (structures) having the same functions as those shown in the drawings pertaining to the embodiments above will be given the same reference symbols, and explanation thereof will be omitted here. The characteristics features of each of the tuners 61 and 62 lie in that the local amplifier 54 is provided between the first stage local oscillation circuit 26 and the mixer circuit 28, and the low pass filter 27 of variable frequency is provided either between the local oscillation circuit 26 and the local amplifier 54, or between the local amplifier 54 and the mixer circuit 28, and the low pass filter 67 of fixed frequency is provided in the other interval either between the local oscillation circuit 26 and the local amplifier 54, or between the local amplifier 54 and the mixer circuit 28.

Additionally, it is necessary to arrange the low pass filter 67 of fixed frequency to allow all the basic components of the local oscillation signal LO1 of variable frequency to pass, and thus, the cut-off frequency fc thereof is set to be higher than the upper limit of the frequency of the local oscillation signal LO1.

In the tuner 61 of FIG. 11, the low pass filter 67 of fixed frequency is provided between the local oscillation circuit 26 and the local amplifier 65, and the low pass filter 27 is provided between the local amplifier 54 and the mixer circuit 28. In the tuner 62 of FIG. 12, the low pass filter of variable frequency is provided between the local oscillation circuit 26 and the local amplifier 54, and the low pass filter 67 of fixed frequency is provided between the local amplifier 54 and the mixer circuit 28.

With this arrangement, even when the receiver frequency is low, it is possible to fully reduce the high harmonic signal, and the characteristics of the wave to be filtered of the high harmonic wave signal can be reduced to a sufficient level, and relatively smooth characteristics of the waves to be filtered of the low pass filter of variable frequency can be achieved.

In replace of the low pass filter 27, the band pass filter 47 may be adopted, and with the structure adopting the band pass filter 47, it is possible to set Q of the band pass filter composed of the LC oscillation circuit to be relatively low.

In the foregoing preferred embodiments, explanations have been given through the double conversion circuit, which performs a two-stage frequency conversion of the high frequency input signal RF. However, the present invention is not intended to be limited to the foregoing structure. The present invention is applicable to the frequency conversion circuit, which performs a plural-stage (two or more stages) frequency conversion of the high frequency input signal RF. As in each of the previous embodiments, by providing a variable frequency filter (low pass filter 27 or band pass filter 47) between the local oscillation circuit for generating the local oscillation signal of variable frequency and the corresponding mixer circuit, and further providing as necessary the local amplifier 54 and the low pass filter 67 of the fixed frequency, even if the frequency of the local oscillation signal is varied, the high harmonic wave can be attenuated to a sufficient level. As a result, the problem of local beat generated by the interference between the high harmonic wave of the local oscillation signal of high harmonic wave and the high harmonic wave of the local oscillation signal of the remaining local oscillation circuit can be eliminated.

The present invention is desirably applied to the frequency conversion circuit for carrying out a frequency conversion using a plurality of local oscillation circuits 26 and 31, particularly to the set top box for receiving CATV of wide frequency band of the input frequency signal and the measuring device.

The frequency conversion circuit of the present invention, which performs a two-stage frequency conversion of a high frequency input signal, is arranged so as to include a variable frequency filter for removing a high harmonic wave of a first stage local oscillation signal. The frequency conversion circuit of the foregoing structure is applicable to, for example, a cable television broadcast receiving set box, which performs a two-stage frequency conversion of a high frequency input signal to obtain an output signal as desired, such as a base band signal, and is provided with the variable frequency filter which is realized, for example, by a low pass filter, or a band pass filter, etc., for removing high harmonic wave of the first stage local oscillation signal. In the frequency conversion circuit, which carries out a two-stage frequency conversion, the first stage local oscillation signal changes in response to a change in frequency of the high frequency input signal; however, the band to be filtered by the variable frequency filter changes in response to a change in frequency of the high frequency input signal. Therefore, the frequency conversion circuit of the foregoing structure is free from the band width restriction, and is applicable to a wide frequency band. Particularly, for the high frequency input signal of low frequency (i.e., the frequency of the first stage local oscillation signal is low), the reference wave component of the first stage local oscillation signal can be passed, and its high harmonic wave can be attenuated to a sufficient level.

By attenuating the high harmonic wave of the first stage local oscillation signal to a sufficient level, the problem of a local beat due to an interference between the high harmonic wave of the first stage local oscillation signal and the high harmonic wave of the second stage local oscillation signal can be eliminated.

Another frequency conversion circuit of the present invention, which performs a two-stage frequency conversion of a high frequency input signal, is arranged so as to include a variable frequency filter whose blocking frequency changes in response to a change in oscillation frequency of the first stage local oscillation signal, for blocking an interference between a high harmonic wave of the first stage oscillation signal and a high harmonic wave of a second stage local oscillation signal.

With this structure, the first stage local oscillation signal changes in response to a change in frequency of the high frequency input signal. However, the frequency conversion circuit is provided with a variable frequency filter whose blocking frequency changes in response to a change in oscillation frequency of the first stage local oscillation signal, for blocking an interference between a high harmonic wave of the first stage oscillation signal and a high harmonic wave of a second stage local oscillation signal. Therefore, the frequency conversion circuit of the foregoing structure is free from the band width restriction, and is applicable to wide frequency band. Particularly, for the high frequency input signal of low frequency (i.e., the frequency of the first stage local oscillation signal is low), the reference wave component of the first stage local oscillation signal can be passed, and its high harmonic wave can be attenuated to a sufficient level. As a result, the problem of a local beat due to an interference between the high harmonic wave of the first stage local oscillation signal and the high harmonic wave of the second stage local oscillation signal can be eliminated.

Another frequency conversion circuit in accordance with the present invention, which performs a plural-stage frequency conversion of a high frequency input signal, is arranged so as to include: a local oscillation circuit for generating a local oscillation signal of variable frequency; a mixer circuit corresponding to the local oscillation circuit; and a variable frequency filter for blocking an interference between a high harmonic wave of the local oscillation signal of variable frequency and a high harmonic wave of a local oscillation circuit from a remaining local oscillation circuit, the variable frequency filter being provided between the local oscillation circuit and the mixer circuit.

In the frequency conversion circuit of the foregoing structure, which performs a plural-stage frequency conversion, the local oscillation circuit which generates a local oscillation signal of variable frequency (for example, a local oscillation signal whose oscillation frequency changes in response to a change in frequency of the high frequency input signal) is provided in at least one of the plural stages. For the local oscillation signal from the local oscillation circuit, the high harmonic wave component is attenuated by the variable oscillation signal before being input to the corresponding mixer circuit. Here, since variable filter is adopted, the band to be filtered can be changed in response to a change in frequency of the local oscillation circuit. Therefore, the frequency conversion circuit of the foregoing structure is free from the band width restriction, and is applicable to wide frequency band. Particularly, for the high frequency input signal of low frequency, the reference wave component of the first stage local oscillation signal can be passed, and its high harmonic wave can be attenuated to a sufficient level.

By attenuating the high harmonic wave of the first stage local oscillation signal to a sufficient level, the problem of a local beat due to an interference between the high harmonic wave of the first stage local oscillation signal and the high harmonic wave of the second stage local oscillation signal can be eliminated.

A frequency conversion circuit, which performs a two-stage frequency conversion of a high frequency input signal is arranged such that the variable frequency filter for removing a high harmonic wave of a first stage local oscillation signal is provided between the first stage local oscillation circuit and the mixer circuit.

With this structure, the first stage local oscillation signal changes in response to a change in frequency of the high frequency input signal; however, the band to be filtered by the variable frequency filter changes in response to a change in frequency of the high frequency input signal. Therefore, the frequency conversion circuit of the foregoing structure is free from the band width restriction, and is applicable to wide frequency band. Particularly, for the high frequency input signal of low frequency (i.e., the frequency of the first stage local oscillation signal is low), the reference wave component of the first stage local oscillation signal can be passed, and its high harmonic wave can be attenuated to a sufficient level.

By attenuating the high harmonic wave of the first stage local oscillation signal to a sufficient level, the problem of a local beat due to an interference between the high harmonic wave of the first stage local oscillation signal and the high harmonic wave of the second stage local oscillation signal can be eliminated.

The frequency conversion circuit of the present invention may be further arranged such that the variable frequency filter is a low pass filter (for example, a variable low pass filter composed of an LC oscillation circuit in combination of a coil and a variable capacitor).

The frequency conversion circuit of the present invention may be further arranged such that the variable frequency filter is a band pass filter (for example, a variable band pass filter composed of an LC oscillation circuit in combination of a coil and a variable capacitor).

With the foregoing structure, the variable frequency filter for removing the high harmonic wave of the local oscillation signal can be realized by the low pass filter or the band pass filter.

The frequency conversion circuit of the present invention may be further arranged so as to include a control section for controlling frequency characteristic of the variable frequency filter in response to a change in frequency of the local oscillation signal.

With this structure, the frequency characteristic of the variable frequency filter changes in response to a change in frequency of the local oscillation signal. Therefore, the frequency conversion circuit of the foregoing structure is free from the band width restriction, and is applicable to wide frequency band.

The frequency conversion circuit of the present invention may be further arranged such that the control section (for example, PLLIC) controls the frequency characteristic of the variable frequency filter in response to a change in frequency characteristic of the local oscillation circuit using a phase lock loop (PLL).

According to the foregoing structure, the frequency characteristic of the variable frequency filter can be controlled automatically by the control circuit adopting the PLL in response to a change in oscillation frequency of the local oscillation circuit.

The frequency conversion circuit of the present invention may be further arranged such that the control section controls the frequency characteristic of the variable frequency filter in response to a change in frequency characteristic of the local oscillation circuit using the voltage synthesizer method.

According to the foregoing structure, the voltage synthesizer is used to control the variable frequency filter. In this voltage synthesizer method, the circuit generating a plurality of predetermined control signal voltages (for example, a voltage corresponding to each of a plurality of receiving bands) is divided into the local oscillation circuit and the variable frequency filter. Then, by selecting a voltage to be applied to the local oscillation circuit, a control signal voltage to be applied to the variable frequency filter corresponding to the selected voltage is selected (for example, by a cooperative switch to be operated by a mechanical dial). With the control using the voltage synthesizer method, a voltage to be applied to the local oscillation circuit and a voltage to be applied to the variable frequency filter can be set separately. As a result, a higher degree of freedom in designing the frequency conversion circuit and making an adjustment can be achieved.

Furthermore, the frequency conversion circuit of the present invention is arranged such that the local amplifier is connected in series with the variable frequency filter.

With the foregoing structure wherein the local amplifier for amplifying the local oscillation signal is provided between the variable local oscillation circuit and the corresponding mixer circuit, two variable frequency filters are provided, one is placed before the local amplifier, i.e., between the local oscillation circuit and the local amplifier, and the other is placed after the local amplifier, i.e., between the local amplifier and the mixer circuit, or before or after the local amplifier, i.e., between the local oscillation circuit and the local amplifier, or between the local amplifier and the mixer circuit.

Therefore, in amplifying the local oscillation signal by the local amplifier, with the structure wherein the variable frequency filter is provided before the local amplifier, the amplification of the local amplifier of the high harmonic wave generated by the local oscillation circuit can be prevented. With the structure wherein the variable frequency filter is provided after the local amplifier, the high harmonic wave newly generated by the local amplifier can be attenuated. As described, the effects of the present invention can be achieved effectively in the structure with the local amplifier.

The present invention may be further arranged such that the local oscillation amplifier is provided between the local oscillation circuit and the mixer circuit, and the variable frequency filter is provided either between the local oscillation circuit and the local amplifier, or between the local amplifier and the mixer circuit, and the local filter of fixed frequency is provided either between the local oscillation circuit and the local amplifier, or between the local amplifier and the mixer circuit, where the variable frequency filter is not provided.

With this structure, the local amplifier for amplifying the local oscillation signal is provided between the local oscillation circuit of a variable frequency and the mixer circuit, and the variable frequency filter is provided either between the local oscillation circuit and the local amplifier, or between the local amplifier and the mixer circuit, and the local filter of fixed frequency is provided either between the local oscillation circuit and the local amplifier, or between the local amplifier and the mixer circuit, where the variable frequency filter is not provided.

Even for the low receiving frequency, the high harmonic signal can be reduced to a sufficient level, and the filter characteristic of the variable frequency filter can be made smooth. Namely, by adopting the band pass filter composed of the LC oscillation circuit for the variable frequency filter, Q can be set to relatively low.

The tuner of the present invention is characterized by adopting any of the foregoing frequency conversion circuit.

With this structure, the receiving band of, for example, the CATV tuner is wide, i.e., in the range of 54 to 860, and in the case where the first stage intermediate frequency is set to 1000 MHz by the frequency conversion tuner, the range of the frequency of the first stage local oscillation signal is set to a range of 1054 to 1860 MHz. Therefore, the high harmonic wave of a frequency two times as high as the first stage intermediate frequency is set to a range of 2108 to 3720 M, and to realize a filter which permits a sufficient attenuation to be achieved at 2108 MHz, the number of stages would be increased, and the number of components, and the number of parts to be adjusted increase, which in turn cases a problem of cost increase. In contrast, according to the frequency conversion tuner of the present invention, a sufficient level of attenuation of the high harmonic wave can be achieved while reducing the factors for increasing the cost to the minimum.

The CATV receiving set top box of the present invention is characterized by including the foregoing tuner. According to the set top box with a wide frequency band of the input frequency signal, the effect as achieved from the present invention will become more obvious.

As described, the frequency conversion circuit of the present invention, which performs a two-stage frequency conversion of a high frequency input signal, may be arranged so as to include a variable frequency filter for removing a high harmonic wave of a first stage local oscillation signal.

The frequency conversion circuit, which performs a two-stage frequency conversion of a high frequency input signal may be arranged so as to include:

a variable frequency filter whose blocking frequency changes in response to a change in oscillation frequency of the first stage local oscillation signal, for blocking an interference between a high harmonic wave of the first stage oscillation signal and a high harmonic wave of a second stage local oscillation signal.

The frequency conversion circuit which performs a plural-stage frequency conversion of a high frequency input signal may be arranged so as to include a local oscillation circuit for generating a local oscillation signal of variable frequency; a mixer circuit corresponding to the local oscillation circuit; and a variable frequency filter is provided between the local oscillation circuit and the mixer circuit.

The frequency conversion circuit which performs a two-stage frequency conversion of a high frequency input signal is arranged so as to include a first stage local oscillation circuit for generating a local oscillation signal of variable frequency; a mixer circuit; and a variable frequency filter for removing the high harmonic wave of the first stage local oscillation signal, the variable frequency filter being provided between the first stage local oscillation circuit and the mixer circuit.

With this structure, by changing the filter band (blocking frequency) of the variable frequency filter in response to the frequency of the high harmonic input signal, the present invention can be applicable to a wide frequency band without restriction of a band width, and a sufficient attenuation of high harmonic wave can be obtained even when receiving low frequency.

The frequency conversion circuit of the present invention may be arranged such that the variable frequency filter is a low pass filter.

The frequency conversion circuit of the present invention may be arranged such that the variable frequency filter is a band pass filter.

With this structure, the variable frequency filter for removing the high harmonic wave of the local oscillation signal can be realized.

The frequency conversion circuit of the present invention may be further arranged so as to include: a control section for controlling frequency characteristic of the variable frequency filter in response to a change in frequency of the local oscillation signal.

With this structure, the frequency conversion circuit, which offers particular effect, can be realized.

As described, the frequency conversion circuit of the present invention may be further arranged such that the control section controls the frequency characteristic of the variable frequency filter using a PLL.

According to the foregoing structure, the frequency characteristic of the variable frequency filter can be controlled automatically in response to a change in oscillation frequency of the local oscillation circuit.

The frequency conversion circuit of the present invention may be further arranged such that the control section controls the frequency characteristic of the variable frequency filter in response to a change in the frequency characteristic of the local oscillation circuit using the voltage synthesizer method.

According to the foregoing structure, a voltage to be applied to the local oscillation circuit and a voltage to be applied to the variable frequency filter can be set separately. As a result, a higher degree of freedom in designing the frequency conversion circuit and making an adjustment can be achieved.

Furthermore, the frequency conversion circuit of the present invention may be arranged such that the local amplifier is connected in series with the variable frequency filter.

According to the foregoing structure, in amplifying the local oscillation signal by the local amplifier, with the structure wherein the variable frequency filter is provided before the local amplifier, the amplification of the local amplifier of the high harmonic wave generated by the local oscillation circuit can be prevented. With the structure wherein the variable frequency filter is provided after the local amplifier, the high harmonic wave newly generated by the local amplifier can be attenuated. As described, the effects of the present invention can be achieved effectively in the structure with the local amplifier.

The frequency conversion circuit of the present invention may be further arranged such that the local oscillation amplifier is provided between the local oscillation circuit and the mixer circuit, and the variable frequency filter is provided either between the local oscillation circuit and the local amplifier, or between the local amplifier and the mixer circuit, and the local filter of fixed frequency is provided either between the local oscillation circuit and the local amplifier, or between the local amplifier and the mixer circuit, where the variable frequency filter is not provided.

According to the foregoing structure, even for the low receiving frequency, the high harmonic signal can be reduced to a sufficient level, and the filter characteristic of the variable frequency filter can be made smooth. Namely, by adopting the band pass filter composed of the LC oscillation circuit for the variable frequency filter, Q can be set to relatively low.

The tuner of the present invention may be arranged so as to adopt any of the foregoing frequency conversion circuit.

According to the foregoing structure, the tuner which is applicable to wide frequency band without band width restriction, and permits the high harmonic wave to be attenuated to a sufficient level even when receiving low frequency.

As described, the CATV receiving set top box of the preset invention is provided with any of the foregoing tuners.

The effect as achieved from the present invention can be more appreciated, when the present invention is applied to a set top box with wide frequency band of a high frequency input signal.

As described, the frequency converter of the present invention which performs a plural-stage frequency conversion of a high frequency input signal, which includes plural-stage frequency converting sections, each including a local oscillation circuit for generating a local oscillation signal and a mixer circuit for converting a frequency of a signal by mixing the signal with the local oscillation signal, is characterized by comprising:

a variable frequency filter which permits a local oscillation signal to pass therethrough while removing a high harmonic component of the local oscillation signal, the variable frequency filter being provided between the local oscillation circuit for generating local oscillation signals of different frequencies and the mixer circuit.

It is preferable that the above frequency converter be further arranged such that the plural-stage frequency converting sections are two-stage frequency converting sections, wherein the variable frequency filter is provided between the local oscillation circuit and the mixer circuit in the first stage of the frequency converting section.

For the variable frequency filter, a variable low pass filter may be adopted.

For the variable frequency filter, a variable band pass filter may be adopted.

It is preferable that the above frequency converter be arranged so as to further include: a control section for changing frequency characteristics of a variable frequency filter in response to a change in oscillation frequency of the local oscillation circuit.

It is also preferable that the above frequency converter be arranged such that the control section includes a PLL which controls the local oscillation signal generated by the local oscillation circuit and the frequency characteristic of the variable frequency filter in relation to one another based on the oscillation frequency of the local oscillation circuit.

It is also preferable that the above frequency converter be arranged such that the control section adopts the voltage synthesizer method to perform a switch control of the frequency characteristic of the variable frequency filter according to the switch of the oscillation frequency of the local oscillation circuit.

It is also preferable that the above frequency converter be arranged such that a local amplifier is connected in series with the variable frequency filter between the local oscillation circuit and the mixer circuit.

It is also preferable that the above frequency converter be arranged such that a local amplifier is provided between the local oscillation circuit and the mixer circuit;

the variable frequency filter is provided either between the local oscillation circuit and the local amplifier, or between the local amplifier and the mixer circuit; and

a low pass filter of a fixed frequency is provided either between the local oscillation circuit and the local amplifier or between the local amplifier and the mixer circuit, where the variable frequency filter is not provided.

As described, another frequency converter of the present invention which performs a plural-stage frequency conversion of a high frequency input signal, which comprises plural-stage frequency converting sections, each including a local oscillation circuit for generating a local oscillation signal and a mixer circuit for converting a frequency of a signal by mixing the signal with the local oscillation signal, is characterized by further comprising:

a variable frequency filter whose blocking frequency changes in response to a change in oscillation frequency of a first stage local oscillation signal, for blocking an interference between high harmonic waves of different stages.

As described, another tuner of the present invention is characterized by adopting a frequency converter which performs a plural-stage frequency conversion of a high frequency input signal, the frequency converter comprising plural-stage frequency converting sections, each including a local oscillation circuit for generating a local oscillation signal and a mixer circuit for converting a frequency of a signal by mixing the signal with the local oscillation signal, the frequency converter further comprising: a variable frequency filter which permits a local oscillation signal to pass therethrough while removing a high harmonic component of the local oscillation signal, the variable frequency filter being provided between the local oscillation circuit for generating local oscillation signals of different frequencies and the mixer circuit.

As described, a still another tuner of the present invention is characterized by adopting a frequency converter which performs a plural-stage frequency conversion of a high frequency input signal, the frequency converter comprising plural-stage frequency converting sections, each including a local oscillation circuit for generating a local oscillation signal and a mixer circuit for converting a frequency of a signal by mixing the signal with the local oscillation signal, the frequency converter further comprising: a variable frequency filter whose blocking frequency changes in response to a change in oscillation frequency of a first stage local oscillation signal, for blocking an interference between high harmonic waves of different stages.

In order to achieve the above object, another CATV receiving set top box of the present invention is characterized by comprising a tuner adopting a frequency converter which performs a plural-stage frequency conversion of a high frequency input signal, the frequency converter comprising plural-stage frequency converting sections, each including a local oscillation circuit for generating a local oscillation signal and a mixer circuit for converting a frequency of a signal by mixing the signal with the local oscillation signal, the frequency converter further comprising:

a variable frequency filter which permits a local oscillation signal to pass therethrough while removing a high harmonic component of the local oscillation signal, the variable frequency filter being provided between the local oscillation circuit for generating local oscillation signals of different frequencies and the mixer circuit.

In order to achieve the above object, another CATV receiving set top box comprising a tuner adopting a frequency converter which performs a plural-stage frequency conversion of a high frequency input signal, the frequency converter comprising plural-stage frequency converting sections, each including a local oscillation circuit for generating a local oscillation signal and a mixer circuit for converting a frequency of a signal by mixing the signal with the local oscillation signal, the frequency converter further comprising:

a variable frequency filter whose blocking frequency changes in response to a change in oscillation frequency of a first stage local oscillation signal, for blocking an interference between high harmonic waves of different stages.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

1. A frequency conversion circuit, which performs a plural-stage frequency conversion of a high frequency input signal, said frequency conversion circuit comprising:
a local oscillation circuit for generating a local oscillation signal of variable frequency;
a mixer circuit corresponding to said local oscillation circuit;
a variable frequency filter for blocking an interference between a high harmonic wave of the local oscillation signal of variable frequency and a high harmonic wave of a local oscillation circuit from a remaining local oscillation circuit, said variable frequency filter being provided between said local oscillation circuit and said mixer circuit; and
a local amplifier connected in series with said variable frequency filter.

2. A frequency conversion circuit, which performs a plural-stage frequency conversion of a high frequency input signal, said frequency conversion circuit comprising:
a local oscillation circuit for generating a local oscillation signal of variable frequency;
a mixer circuit corresponding to said local oscillation circuit;
a variable frequency filter for blocking an interference between a high harmonic wave of the local oscillation signal of variable frequency and a high harmonic wave of a local oscillation circuit from a remaining local oscillation circuit, said variable frequency filter being provided between said local oscillation circuit and said mixer circuit;
a local amplifier provided between said local oscillation circuit and said mixer circuit, said variable frequency filter being provided between said local oscillation circuit and said local amplifier; and
a low pass filter of a fixed frequency provided between said local amplifier and said mixer circuit.

3. A frequency conversion circuit, which performs a plural-stage frequency conversion of a high frequency input signal, said frequency conversion circuit comprising:
a local oscillation circuit for generating a local oscillation signal of variable frequency;
a mixer circuit corresponding to said local oscillation circuit;
a variable frequency filter for blocking an interference between a high harmonic wave of the local oscillation signal of variable frequency and a high harmonic wave of a local oscillation circuit from a remaining local oscillation circuit, said variable frequency filter being provided between said local oscillation circuit and said mixer circuit;
a local amplifier provided between said local oscillation circuit and said mixer circuit, said variable frequency filter being provided between said local amplifier and said mixer circuit; and
a low pass filter of a fixed frequency provided between said local oscillation circuit and said local amplifier.
